(19) United States
(12) Patent Application Publication
(10) Pub. No.: US 2012/0279789 A1
(43) Pub. Date: Nov. 8, 2012

(54) DETACHABLE POWER DRIVE UNIT FOR PROPELLING AND STEERING MANUAL WHEELCHAIRS

(76) Inventors: Bradley Brill, Farmington Hills, MI (US); Eric Damphousse, Saint Claire Shores, MI (US); Darrel Kleinke, Livonia, MI (US); Galen Masdon, Rochester Hills, MI (US)

(21) Appl. No.: 13/462,083

(22) Filed: May 2, 2012

Related U.S. Application Data
(60) Provisional application No. 61/481,379, filed on May 2, 2011.

(51) Int. Cl. A61G 5/04; A61G 5/02

(52) U.S. Cl. 180/6.5

(57) ABSTRACT

A detachable power drive unit for propelling and steering a manual wheelchair is provided which comprises a frame, two independently controlled drive wheels, a power source, a hitching unit for coupling the device to the wheelchair, a force transfer apparatus, a user interface and a controller. The frame, motors, batteries and wheels have a low profile, which allows them to fit in the space underneath a standard manual wheelchair. The hitching unit couples the device to the wheelchair, yet allowing a fair degree of rotational motion to occur which minimizes the possibility of a wheel losing contact with the ground. The force transfer apparatus is a spring loaded arm that gets compressed by the wheelchair chassis during docking, thus transferring a significant portion of the wheelchair and occupant weights onto the drive wheels and ensuring adequate ground contact force and, as a consequence, drive traction.

### CROSS-REFERENCE TO RELATED APPLICATIONS

The present application claims priority under 35 USC §119 based on U.S. Provisional Application No. 61/481,379 filed on May 2, 2011. The entire subject matter of this priority document is herein incorporated by reference.

### BACKGROUND OF THE INVENTION

1. Field of the Invention

The present invention relates generally to wheelchairs. More specifically, the present invention relates to a detachable, power drive unit for manual wheelchairs capable of propelling and steering said wheelchair and of being attached and detached by the wheelchair occupant without any assistance.

2. Description of the Background Art

There are over a million manual wheelchair users in the United States in 2010. Manual wheelchairs are designed to be comfortable, lightweight, maneuverable and can be easily folded and stowed away. These salient features come at the cost of the occupant having to propel the wheelchair by manual force or rely on external help to push the wheelchair. Power wheelchairs on the other hand are very useful when covering long distances or when the occupant is unable to generate the forces required. An attractive solution is to have a power drive unit that could be easily attached to propel a manual wheelchair then easily detached when no longer needed. In this way, the wheelchair user need not compromise between lightweight maneuverability and powered transportation.

There are a variety of patented assistive devices to help propel manual wheelchairs, only a handful of which are commercially available. They generally fall into two categories: devices that are located in front and pull the wheelchair; and, others that are located behind and push the wheelchair.

The pull-type devices are steered directly by the wheelchair occupant using “bicycle handlebars” type interface as used in U.S. Pat. No. 5,016,720 (1991) to Coker (a detachable electric drive unit for collapsible wheelchair) and U.S. Pat. No. 7,216,728 B2 (2007) to Huang (a motorized apparatus for towing a wheelchair) among many others. One drawback of these types of embodiments is that the device is located ahead of the wheelchair, which restricts the ability of the occupant to get near stationary objects such as tables and sinks. Another drawback concerns the low contact force between the drive wheel/s and the ground stemming from the inability of the occupant to exert down force as most of his/her weight is borne by the wheelchair wheels. This significantly limits the traction to the ground and the ability of the device to propel the wheelchair on loose or slippery surfaces.

The push-type devices are generally located either in the space underneath the occupant or immediately behind the wheelchair and attach directly to the frame. There are two main architectures to these devices: one with a single drive wheel located at the wheelchair centerline; and the other with two or more drive wheels. With very few exceptions, the push-type devices found in the patent search have a force transfer mechanism that transfer a portion of the occupied wheelchair weight off the wheelchair wheels and onto the drive wheels. In that sense, the push-type architecture is far superior to the pull-type one.

Patent examples with single drive wheel architecture are: U.S. Pat. No. 5,135,063 (1992) to Kropf (a power unit for driving manually-operated wheelchair); U.S. Pat. No. 5,222,567 (1993) to Broadhead (a power assist device for a wheelchair); U.S. Pat. No. 4,759,418 (1988) to Goldenfeld (a wheelchair drive); U.S. Pat. No. 6,334,497 B2 (2002) to Odell (a wheelchair motorizing apparatus); and U.S. Pat. No. 6,860,347 B2 (2005) to Sinclair (a wheelchair drive unit). These patents specifically, and all others with similar architecture can only be steered by orienting the drive wheel assembly which is exceedingly difficult in the confined space underneath and directly behind a wheelchair.

Patents with dual drive wheel architecture are: U.S. Pat. No. 6,481,514 B2 (2002) to Takada (an auxiliary power device of wheelchair); and U.S. Pat. No. 7,886,854 B2 (2011) to Chiu (a wheelchair). These two patents generally relate to the attachment mechanism and not to the drive mechanism. The paucity of patents with multiple drive wheels stems from a condition known as kinematic lockup where motion becomes either impossible or severe the scrubbing will result unless very particular kinematic conditions are observed. Also, with multiple drive wheels, a situation could exist where one of the wheels will break contact with the ground in uneven terrain unless the wheels are able to adjust to the terrain.

All of the above-listed patents include various features and inventions which may be used to mechanize and propel a manual wheelchair; however, they generally suffer from either excessive size, lack of traction or difficulty in steering and tire scrubbing. Invariably, they all suffer from the fact that they require extensive operations and or controls to attach/detach and thus could not be done by the wheelchair occupant unaided. As such, a need still exists in the art for an improved detachable and steerable push-type wheelchair power unit.

### SUMMARY OF THE INVENTION

Accordingly, the present invention has been made to overcome the drawbacks of the previously known power units for manual wheelchairs. It is an object of the present invention to provide a power drive unit for pushing a manual wheelchair that is capable of being attached/detached by the wheelchair occupant without external help.

It is a further object of the present invention to provide a power drive unit for pushing a manual wheelchair that is capable of being steered and thus allowing the occupant to control the speed and the heading of the wheelchair.

It is still a further object of the present invention to provide a power drive unit for pushing a manual wheelchair that includes a force transfer mechanism for maintaining sufficient contact force between the drive wheels and the ground.

It is still a further object of the present invention to provide a power drive unit for pushing a manual wheelchair that allows for the drive wheels as well as the wheelchair wheels to maintain contact with the ground at all times.

It is still a further object of the present invention to provide a power drive unit for pushing a manual wheelchair that could be controlled using an electronic input device accessible to the wheelchair occupant.

The objects of the present invention are achieved and the disadvantages of the prior art are overcome by the present invention which provides a power drive unit for manual wheelchair comprising a frame, two independently controlled drive wheels, a battery, a hitching unit for coupling the device to the wheelchair, a force transfer apparatus, a user interface and a controller. The frame, motors, batteries and wheels have a low profile which allows them to fit in the space underneath a standard manual wheelchair. The hitching unit couples the device to the wheelchair, yet allowing a fair degree of rotational motion to occur which minimizes the possibility of a wheel losing contact with the ground. The force transfer apparatus is a spring loaded arm that gets compressed by the wheelchair chassis during docking, thus transferring a significant portion of the wheelchair and occupant weights onto the drive wheels and ensuring adequate ground contact force and, as a consequence, drive traction. The user interface device relays inputs from the operator to the controller which independently powers the drive motors to ensure a corresponding amount of forward and turning motions.

There have thus been outlined, rather broadly, some of the features of the invention in order that the detailed description thereof may be better understood, and in order that the present contribution to the art may be better appreciated. There are additional features of the invention that will be described hereinafter.

Other objects, advantages and salient features of the present invention will become apparent to the skilled artisan with reference to the exemplary embodiments of the invention discussed hereafter with reference to the appended drawings. To accomplish the above and related objects, this invention may be embodied in the form illustrated in the accompanying drawings, attention being called to the fact, however, that the drawings are illustrative only, and that changes may be made in the specific construction illustrated and described within the scope the claimed invention.

### BRIEF DESCRIPTION OF THE DRAWINGS

FIG. 1 is an upper perspective view of the present invention showing the power drive unit engaged to the manual wheelchair.

FIG. 2 is an upper perspective view of the present invention showing the power drive unit lined up with the manual wheelchair at the onset of docking procedure.

FIG. 3 is a side view of the power drive unit in the engaged state with the manual wheelchair.

FIG. 4 is a side view of the power drive unit lined up with the manual wheelchair at the onset of docking procedure.

FIG. 5 is a upper perspective view of the power drive unit.

### DETAILED DESCRIPTION OF THE ILLUSTRATIVE EMBODIMENT

An illustrative embodiment of the present invention will now be described in detail, with reference to the accompanying drawings. It should be understood that only structures considered necessary for clarifying the present invention are described herein. Other conventional structures, and those of ancillary and auxiliary components of the system, will be known and understood by those skilled in the art. Throughout the following detailed description and in the drawings, like numbers refer to like parts.

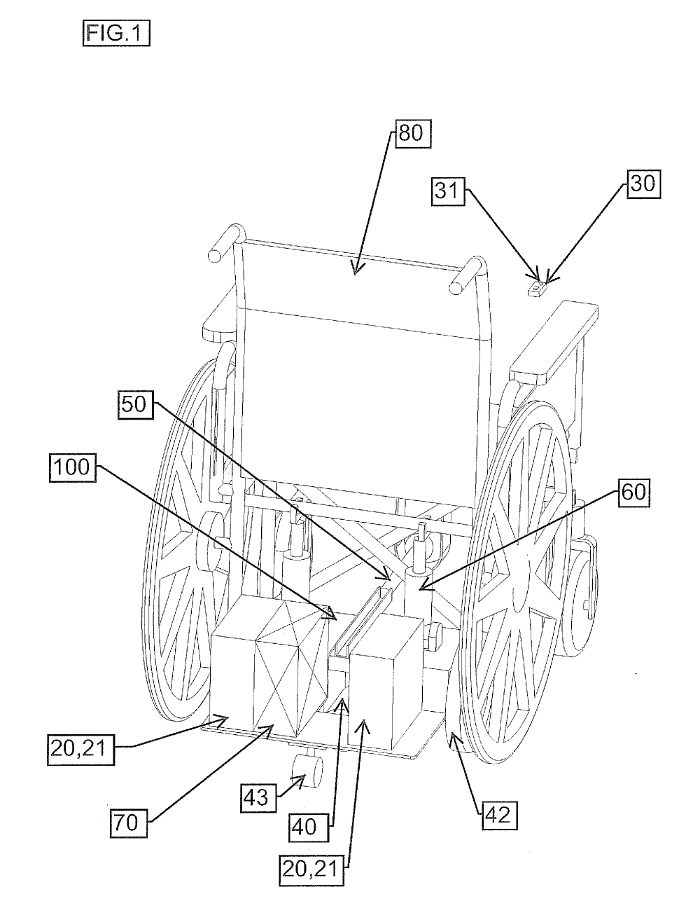

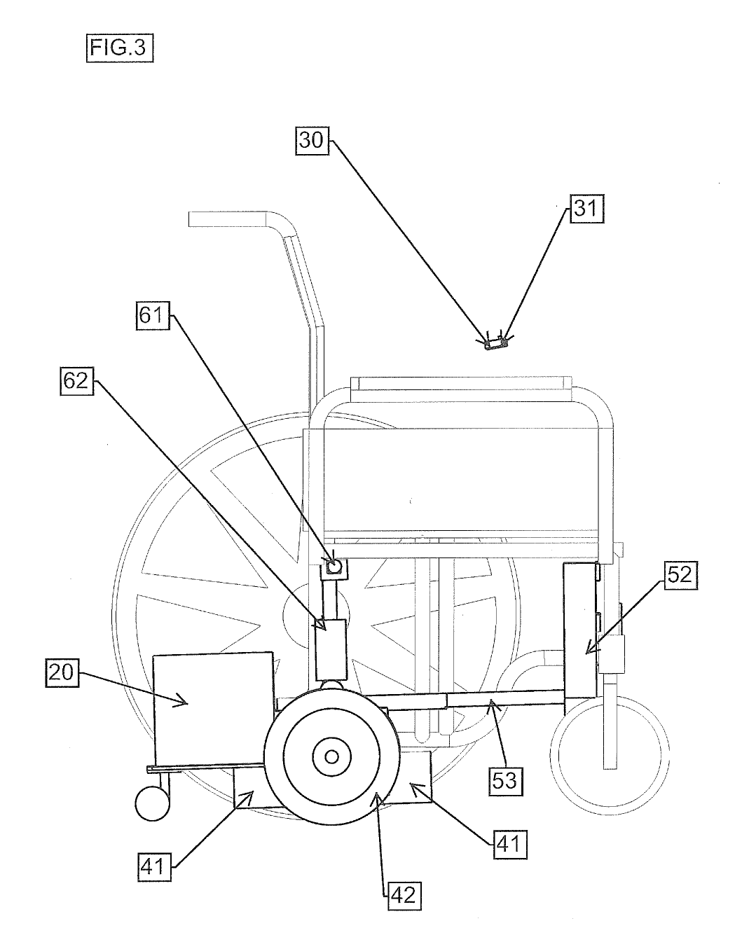

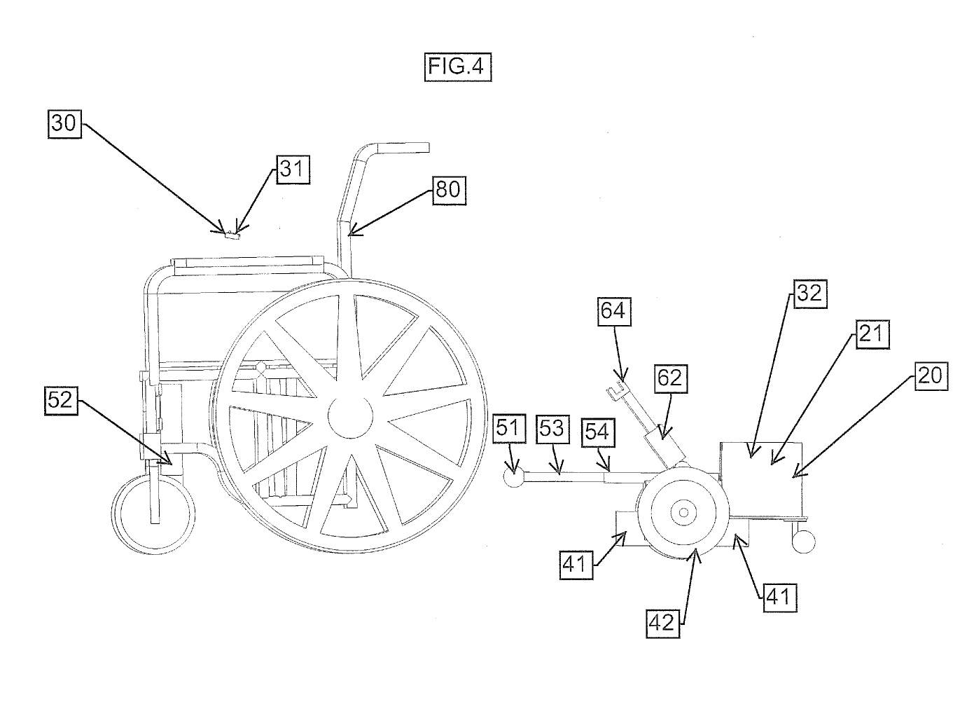

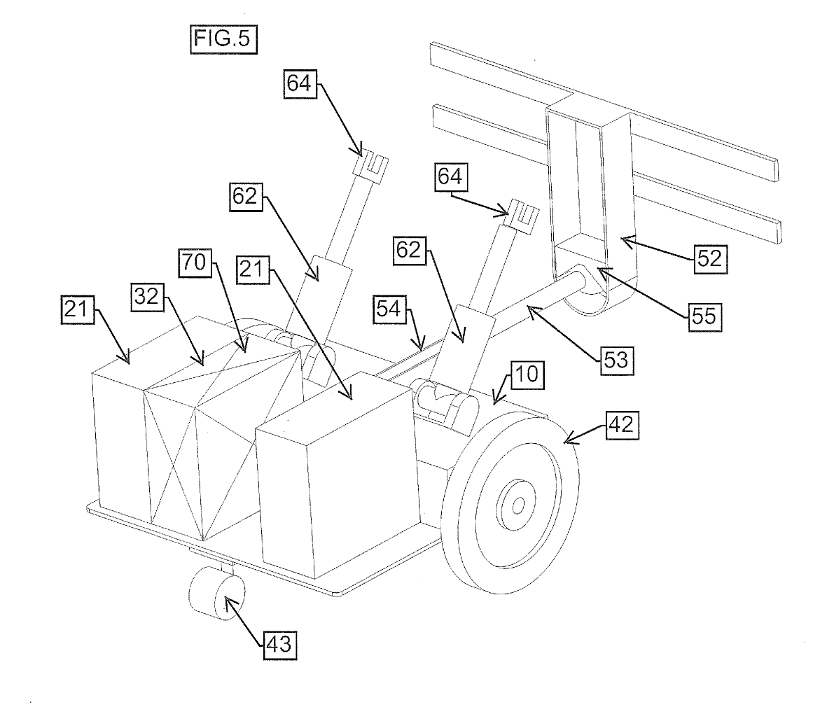

Referring now to FIGS. 1-5, there is shown a detachable power drive unit according to an illustrative embodiment of the present invention. The detachable power drive unit is generally denoted by reference numeral 100, and includes a frame 10, an electrical power unit 20, a user interface 30, a drive train 40 with two independently controlled drive wheels 42, a hitching unit 50, a force transfer apparatus 60 and a motor controller 70.

### Frame 10

The frame 10 is the physical structure on which the various subsystems of the invention attach. The frame 10 provides rigid mounting for the drive wheels 42 and transfer the drive force to the wheelchair for either propulsion or braking through the hitching unit 50 and particularly, the connecting rod 53. The frame also provides rigid attachment points for the force transfer apparatus 60 and particularly the hinges 63. In this embodiment, the frame is constructed of welded hollow tubes and sheet metal but, for weight and portability considerations, the frame could be constructed using lighter materials.

The frame 10 provides a platform and various places to connect the various subsystems and components. The frame 10 directly connects and supports the electrical power unit 20 including the batteries 21, the control module 32 of the user interface 30 as well as the drivetrain 40 including the motors 41.

Electrical Power unit 20

The electrical power unit 20 is the subsystem that provides electrical power to the drive motors 41 and the controller 32. In the present embodiment, the power is supplied by one or more batteries 21. The electrical power unit 20 is the subsystem that includes said batteries and any necessary connections to enable these batteries to power the device.

The batteries could be of any type and any configuration capable of powering the power drive unit 100. The preferred embodiment involves a mechanism to easily detach the batteries from the device. A quick connect mechanism where the batteries slide on tracks and engage a power plug at the end of travel is envisioned. The functional benefits of detachable batteries are the ability to significantly lighten the device for transportation and storage purposes as well as the ability to swap batteries for continuous operations. This benefit comes with the operational drawback of not having a built-in charger, which is the case in most power wheelchairs.

Electric power could alternately be generated on board the device through one of a number of technologies such as fuel cells, or internal combustion engines. Regardless, the choice of power source is a functional decision that has little bearing on the operation of the power drive unit.

### User Interface 30

The user interface 30 transmits the wishes of the wheelchair occupant in the form of inputs to the controller 32. The preferred embodiment of the interface is a form of a joystick 31, not unlike the standard joysticks in use on current power wheelchairs. In the preferred embodiment, the communication between joystick 31 and controller 32 is wireless. The choice of wired versus wireless communication is also a functional decision and has little bearing on the operation of the power drive unit.

The joystick 31 can either be part of a handheld structure or could be fastened to any part of the wheelchair that can be reached by the occupant. The user interface 30 includes visual cues that prompt the user to orient it such that a forward motion of the joystick 31 will cause a forward motion of the wheelchair. In that fashion, manipulating the joystick in a certain direction will cause a corresponding motion of the wheelchair in the same direction. The velocity of the wheelchair is proportional to the level of motion of the joystick.

While a joystick is the preferred embodiment, there are many alternatives that could accomplish the same effect such as a capacitive touch screen, a keyboard, a mouse, a touchpad, a space ball, among a plethora of other input devices.

### Drivetrain 40

The drivetrain 40 is comprised of two independently controlled drive motors 41, each connected to a drive wheel 42. The drive wheels 42 are either connected to the motor shaft directly or through a drive shaft which is supported by one or more bearings. The motors and the bearings are connected to the frame 10. An unpowered castor wheel 43 is included to keep the power drive unit 100 horizontal.

The locations of the drive wheels 42 are of critical importance to the ability of the power drive unit 100 to steer the wheelchair 80. In the preferred embodiment, the drive wheels 42 are located such that their points of contact with the ground and the wheelchair wheels 81 points of contact with the ground are along the same line. This particular architecture where the fixed wheels (non-steerable wheels) ground contacts lie along a single line eliminates the possibility of wheel scrubbing, which in turn ensures minimum friction and energy waste.

The preferred embodiment requires that the power drive unit 100 be fitted to the intended manual wheelchair 80 to insure that the ground contacts of all non-steerable wheels form a single line. To meet this requirement, the length of the connecting rod 53 of the hitching unit 50 is made adjustable by sliding it over a u-shaped runner 54. The connecting rod 53 is then rigidly fixed to the runner 54 once the drive wheels 42 are judged to be in line with the wheelchair wheels 81.

The preferred embodiment results in a natural alignment between the power drive unit 100 and the wheelchair 80. This means that operating forces would always tend to push the device back into alignment with the wheelchair. As a result, the latching mechanism 50 can be fairly loose fitting and made to accommodate several degrees of angular misalignment. This brings enormous benefits during the act of docking the device to the wheelchair as perfect alignment is not necessary prior to engaging the two systems.

Another benefit to the preferred embodiment is that the wheelbase (distance between the drive wheels 42) can be made as wide as space permitting. A wider wheelbase allows for less torque requirement on the drive wheels 42, which in turn would mean that the drive motors 41 and the batteries 21 could be made smaller and lighter. Subsequently, this will have enormous positive implications on the portability of the power drive unit 100.

### Hitching Unit 50

The hitching unit 50 is the subsystem that connects the power drive unit 100 to the wheelchair 80. The hitching unit 50 consists of two subsystems. The first subsystem consists of a link element 51 attached at the end of a connecting rod 53, which in turn connects to the frame 10 via a runner 54. The second subsystem consists of a wheelchair connection adaptor 52 and a latching mechanism 55.

In the preferred embodiment, the hitching of the power drive unit 100 to the wheelchair 80 occurs through a ball and socket joint. Thus, the link element 51 is a “ball” consisting of a spherical hard surface that is rigidly attached to the connecting rod 53. Correspondingly, the wheelchair connection adaptor 52 is a “socket” consisting of a spherical cavity with a rigid structure. The latching mechanism could be any device that traps the “ball” inside the “socket” and thus allows for force and motion transfer, both fore-aft and side-to-side. The preferred embodiment stipulates the presence of a soft, high damping layer of material between the hard. surfaces of the link element 51 and the connection adaptor 52.

In the preferred embodiment, the latching mechanism 55 is a fork-like structure that is actuated mechanically by the wheelchair occupant. The mechanical actuation occurs through a screw system that translates the ball inside a runner. Other mechanical actuation systems could be envisioned including a plethora of mechanisms, cams and linkages. The latching mechanism could also be electrically actuated using a solenoid or other devices.

In an alternative embodiment, the “ball” could be installed as part of the wheelchair and will thus be the connection adaptor 52 while the “socket” is installed at the end of the connecting rod 53 and will thus be the link element 51. This arrangement is very beneficial in the case of an electrically actuated latching mechanism in that electrical power need not be present on the manual wheelchair.

A critical benefit of the preferred embodiment of the “ball and socket” joint is that it allows for angular motion of the power drive unit 10 with respect to the wheelchair 80. This angular motion includes a limited but sufficient amount of pitch, roll and yaw which are necessary to maintain proper ground contact of the drive wheels. This is particularly important in irregular terrain and in light of the fact that this power drive unit 10 is controllable only if both wheels have adequate ground contact force.

### Force Transfer Apparatus 60

The force transfer apparatus 60 is used for the sole purpose of transferring a portion of the wheelchair weight onto the drive wheels 42. The controllability of the power drive unit 100 is contingent on both drive wheels having adequate ground contact force and subsequently, driving traction. Should one of the drive wheels 42 loose traction, the device will cause radical turning motions of the wheelchair 80 for any motion of the joystick 31. This loss of traction could occur as a result of one of the wheels being in contact with a low friction surface such as a wet area or a gravel patch.

This added traction force on the drive wheels would be necessary in cases where the wheelchair needs to climb a short step or a mild incline. In any case, the preferred operation is one where the performance of the power drive unit 100 is limited by the torque available to the drive wheels 42, then by the traction of said wheels.

In the preferred embodiment, the force transfer apparatus 60 consists of two mating subsystems: one that is fixed to the wheelchair and consists of a transversally mounted and horizontally oriented supporting rod 61; the other is mounted on the frame 10 and consists of one or more spring loaded telescoping linear elements 62, each of which attaches through a hinge to the frame 10. The other end of the telescoping linear element 62 has a u-shaped receptacle 64. The resting position of the telescoping linear elements is tilted forward in such a way that it mates the supporting rod 61. As the power drive unit 10 gets further underneath the wheelchair 80, the telescoping linear elements get compressed and exert a lifting force on the wheelchair 80 and a downward force on the power drive unit 10.

Alternative embodiments of the force transfer apparatus 60 could include any passive or active device that exerts a force, such as a wedge, a cam, an electric linear actuator or a pneumatic or hydraulic actuator.

### Operation of the Illustrative Embodiment

The preferred sequence of operation starts with the power drive unit 100 being placed on the floor. As the batteries 21 are charged outside of the device, they will most likely not be part of the power drive unit 100 and thus must be installed onto the device. Once the batteries 21 are installed, the controller 32 goes on standby mode where the device can thus be activated using the remote signal from the user interface 30.

The wheelchair occupant initiates a docking maneuver consisting of using the joystick 31 to drive the unattached power drive unit 100 and orienting it appropriately. The forward motion of the joystick 31 will lead to a forward motion of the power drive unit by powering both wheels at the same speed. A sideways motion of the joystick 31 will lead to a combination of a forward and a turning motion of the power drive unit 100 such that the link element 51 (a spherical ball in the illustrative embodiment) exhibits a pure sideways motion.

The relationship between the forward velocity Vₓ of the link element 51 and the drive wheel velocities V_{L} and V_{R}, for the left and right drive wheels respectively, is given by Vₓ=(V_{L}+V_{R})/2. The relationship between the velocity in the leftward direction V_{y} of the link element 51 (as observed by a person standing behind the device) and the left and right drive wheel velocities is given by V_{y}=(V_{R}−V_{L})*s/d where s is the distance between the link element 51 and the centerline of the drive wheels 42, and d is the distance between the left and right drive wheels.

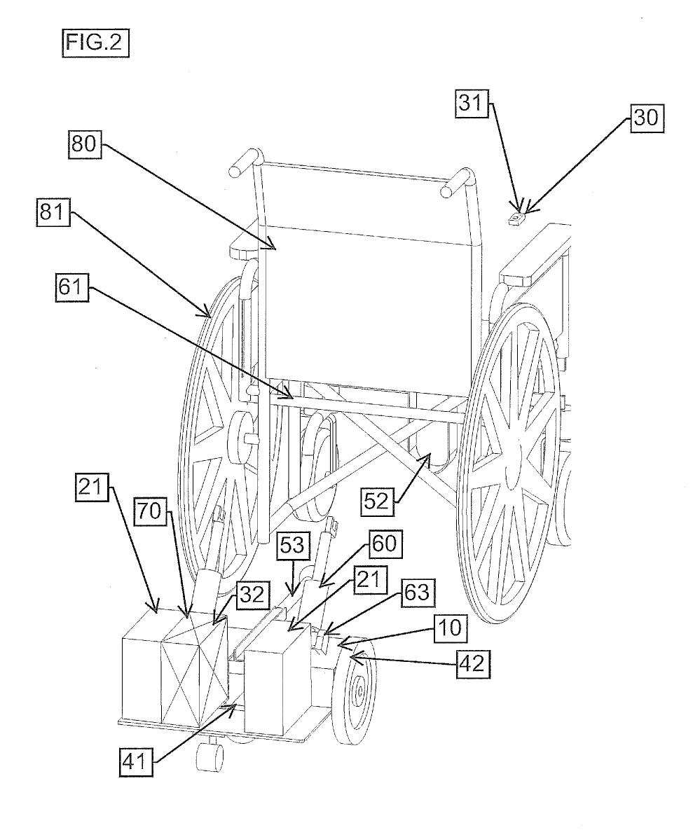

Once the device is oriented properly as shown in FIG. 2, it is parked and the wheelchair occupant backs the wheelchair over the power drive unit 100. The parking of the power drive unit 100 is done by commanding the drive motors to maintain zero velocity. With the device at the appropriate location, meaning that the link element 51 and the wheelchair connection adaptor 52 (the ball and socket) are connected, the wheelchair occupant engages the latching mechanism 55 which couples the two, yet allowing a fair degree of rotational motion to occur.

In the process of docking the power drive unit 100, the spring loaded telescoping linear elements 62 engage the horizontally oriented supporting rod 61 and get compressed, thus transferring a significant amount of load onto the drive wheels.

The propelling and steering of the wheelchair follows the same procedure as the power drive unit with the operator controlling the forward and sideways velocities of the wheelchair connecting adaptor 52. The heading of the wheelchair follows the motion of that point.

The power drive unit 100 is detached from the wheelchair by reversing the sequence of operation. The wheelchair occupant starts by commanding the motors to brake. Then, the wheelchair occupant disengages the latching mechanism 55 and manually propels the wheelchair forward, leaving the parked power drive unit 100 behind. The next steps would be to release the motor brakes and put the power drive unit 100 in standby mode. In the case where the power drive unit 100 needs to be removed and stowed, the batteries are independently removed and stowed, significantly lightening the weight of the unit. The power drive unit can then be independently lifted and stowed.

What is claimed is:

1. A detachable power drive unit which fits underneath or immediately behind a manual wheelchair, comprising:
a frame;
two independently controlled drive wheels attached to said frame;
a hitching unit for coupling the frame to a manual wheelchair;
a user interface consisting of an input device such as a joystick; and
a controller which receives the inputs from the operator through the joystick and controls the rotation of said drive wheels based on said inputs, wherein
said hitching unit can be adjusted such that ground contacts of drive wheels and wheelchair wheels form a straight line,
said drive wheels, having ground contacts in line with wheelchair wheels, can drive wheelchair in any direction, fore-aft, side-to-side and rotation-in-place without excessive tire scrubbing.
said controller translates joystick inputs into wheelchair heading and speed and powers drive wheels independently to achieve said heading and speed.

2. The detachable power drive unit of claim 1 further comprising a hitching unit consisting of a ball and socket joint that allows for drive wheels to move with respect to the wheelchair, thus maintaining a continual and adequate ground contact while travelling on irregular terrain.

3. The detachable power drive unit of claim 2, further comprising a force transfer device that engages the wheelchair during docking and transfers a portion of the occupied wheelchair weight onto the drive wheels for better ground traction.

4. The detachable power drive unit of claim 3, further comprising a latching mechanism that can be operated independently by the wheelchair occupant, which allows said occupant to attach and detach said power drive unit from said wheelchair unaided.
